(19) United States
(12) Patent Application Publication
(10) Pub. No.: US 2025/0156756 A1
(43) Pub. Date: May 15, 2025

(54) Systems and Methods for Pretraining Models for Diverse Downstream Tasks

(71) Applicant: Google LLC, Mountain View, CA (US)

(72) Inventors: Yi Tay, Singapore (SG); Mostafa Dehghani, Amsterdam (NL)

(21) Appl. No.: 18/835,666

(22) PCT Filed: Dec. 30, 2022
(86) PCT No.: PCT/US2022/054370

§ 371 Date: Aug. 2, 2024

Related U.S. Application Data
(60) Provisional application No. 63/305,910, filed on Feb. 2, 2022.

(51) Int. Cl. G06N 20/00

(52) U.S. Cl. CPC G06N 20/00

(57) ABSTRACT

An example method for pretraining a machine-learned model is provided. The example method includes obtaining a plurality of different combinations of configuration parameters of a pretraining objective framework. The example method includes generating, using the pretraining objective framework, a plurality of corrupted training examples from one or more training examples, wherein the plurality of corrupted training examples are respectively generated according to the plurality of different combinations. The example method includes inputting the plurality of corrupted training examples into the machine-learned model, wherein the machine-learned model is configured to generate uncorrupted subportions corresponding to corrupted subportions of the corrupted training examples. The example method includes obtaining, from the machine-learned model, a plurality of outputs respectively generated by the machine-learned model based on the plurality of corrupted training examples. The example method includes updating one or more parameters of the machine-learned model based on an evaluation of the plurality of outputs.

### PRIORITY CLAIM

The present application claims priority to and the benefit of U.S. Provisional Patent Application No. 63/305,910, filed Feb. 2, 2022. U.S. Provisional Patent Application No. 63/305,910 is hereby incorporated by reference herein in its entirety.

### FIELD

The present disclosure relates generally to pretraining machine-learned models. More particularly, the present disclosure relates to improved objectives for pretraining.

### BACKGROUND

The training of machine-learned models can be completed in stages. A model can be pre-trained for general release and subsequently fine-tuned for specific tasks. Pre-training can include pursuit of unsupervised objectives across unlabeled training datasets, often followed by supervised learning on smaller, labeled datasets in the fine-tuning stage.

### SUMMARY

Aspects and advantages of embodiments of the present disclosure will be set forth in part in the following description, or can be learned from the description, or can be learned through practice of the embodiments.

One example aspect of the present disclosure is directed to an example computer-implemented method for pretraining a machine-learned model with diversified objectives. The example method can include obtaining a plurality of different combinations of configuration parameters of a pretraining objective framework. The example method can include generating, using the pretraining objective framework, a plurality of corrupted training examples from one or more training examples. The plurality of corrupted training examples can be respectively generated according to the plurality of different combinations of configuration parameters. The example method can include inputting the plurality of corrupted training examples into the machine-learned model. The machine-learned model can be configured to generate uncorrupted subportions corresponding to corrupted subportions of the corrupted training examples. The example method can include obtaining, from the machine-learned model, a plurality of outputs respectively generated by the machine-learned model based on the plurality of corrupted training examples. The example method can include updating one or more parameters of the machine-learned model based on an evaluation of the plurality of outputs.

In another aspect, example embodiments of the present disclosure provide an example non-transitory, computer-readable medium storing instructions that are executable to cause one or more processors to perform example operations. The example operations can include obtaining a plurality of different combinations of configuration parameters of a pretraining objective framework. The example operations can include generating, using the pretraining objective framework, a plurality of corrupted training examples from one or more training examples. The plurality of corrupted training examples can be respectively generated according to the plurality of different combinations of configuration parameters. The example operations can include inputting the plurality of corrupted training examples into the machine-learned model. The machine-learned model can be configured to generate uncorrupted subportions corresponding to corrupted subportions of the corrupted training examples. The example operations can include obtaining, from the machine-learned model, a plurality of outputs respectively generated by the machine-learned model based on the plurality of corrupted training examples. The example operations can include updating one or more parameters of the machine-learned model based on an evaluation of the plurality of outputs.

In another aspect, example embodiments of the present disclosure provide an example system including one or more processors and the example non-transitory, computer-readable medium.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs pretraining according to example embodiments of the present disclosure.

FIG. 1B depicts a block diagram of an example computing device that performs pretraining according to example embodiments of the present disclosure.

FIG. 1C depicts a block diagram of an example computing device that performs pretraining according to example embodiments of the present disclosure.

FIG. 2 depicts a block diagram of an example pretraining framework according to example embodiments of the present disclosure.

FIG. 3A depicts a block diagram of example training examples according to example embodiments of the present disclosure.

FIG. 3B depicts a block diagram of example corrupted training examples according to example embodiments of the present disclosure.

FIG. 4A depicts a block diagram of example corrupted training examples according to example embodiments of the present disclosure.

FIG. 4B depicts a block diagram of example corrupted training examples according to example embodiments of the present disclosure.

FIG. 5 depicts a flow chart diagram of an example method to perform pretraining according to example embodiments of the present disclosure.

Reference numerals that are repeated across plural figures are intended to identify the same features in various implementations.

### DETAILED DESCRIPTION

### Overview

Example aspects of the present disclosure provide systems and methods for pretraining machine learned models for diverse downstream tasks. In some embodiments, systems and methods of the present disclosure leverage a plurality of pretraining objectives to simulate diverse implementations. In some embodiments, the pretraining objectives can be based on a pretraining objective framework that provides for efficient construction of a diverse set of pretraining objectives by adjusting parameters of the common framework.

A plurality of pretraining objectives can be configured based on a shared pretraining objective framework. For instance, a denoising objective framework can correspond to corrupting one or more selected subportion(s) of a training example (e.g., “noising”) and subsequently predicting/recovering the selected subportion(s) based on a remainder of the training example, such that the original training example can be reconstructed (e.g., “denoising”). A diverse plurality of pretraining objectives can be obtained by adjusting one or more configuration parameters of the shared pretraining objective framework. For example, the one or more configuration parameters can characterize a quantity of the selected subportion(s), a size of the selected subportion(s), a rate at which the selected subportion(s) are corrupted, etc.

Advantageously, systems and methods according to example aspects of the present disclosure can provide for a unified approach to model selection, development, and implementation. For example, in some embodiments, a machine-learned model can be configured for processing sequential information (e.g., language strings, genetic sequencing, other sequenced data). For instance, the model can be configured to understand, generate, respond to, or otherwise interact with sequences of data. Pretraining a model according to example embodiments of the present disclosure can provide a “universal” model effective to perform a variety of different downstream tasks with respect to sequenced data (e.g., the same or different sequenced data), optionally with or without subsequent fine-tuning.

Traditional techniques, in contrast, point to model selection based on the downstream tasks. The plethora of distinct model arrangements, architectures, training recipes, training datasets, etc. can be overwhelming, leading to uninformed choices or otherwise suboptimal model implementations. Furthermore, even if a model may be appropriately selected for a given task, that model may need to be reconfigured or even replaced if the tasks or other requirements change. For example, traditional approaches to processing sequenced data have often relied on different categories of pretraining approaches. For instance, in the context of natural language processing, one prior approach includes pretraining with a language-modeling objective which unidirectionally generates sequences of text based on preceding textual content. Another approach includes pretraining with a masked language objective which identifies masked text based on surrounding text (e.g., bidirectionally). But these pretraining objectives have generally proved inadequate for diverse implementations: for example, open-text generation and prompt-based learning can be an unfavorable setting for traditional masked language objectives, whereas traditional language modeling approaches can be unduly inhibited by purely unidirectional causality.

Therefore, systems and methods according to example aspects of the present disclosure can provide a number of technical effects and advantages over prior approaches. For instance, a unified approach according to example aspects of the present disclosure can provide for implementation of a small number models (e.g., one model) in place of many models (e.g., multiple models). This can decrease the computational complexity of deploying the models, training the models, updating the models, deactivating the models, etc. In this manner, for instance, decreased computational resources can be used to perform model operations with the unified techniques disclosed herein. Decreased storage can be used to store a small number of models (e.g., one model) in place of many models (e.g., multiple models). Decreased network transmissions can be used to implement a small number of models (e.g., one model) in place of many models (e.g., multiple models) on one or more remote device(s) (e.g., client devices connected to a server device). Efficiency of update and patch cycles can be improved by devoting resources (e.g., computational resources, human resources, etc.) to managing and versioning a small number of models (e.g., one model) in place of many models (e.g., multiple models). By using a model trained with a diversified pretraining approach according to example aspects of the present disclosure, a target performance can be achieved with less computational overhead by leveraging a small number of models (e.g., one model) in place of many models (e.g., multiple models). Lower latency can be achieved by using a small number of models (e.g., one model) instead of switching between many models (e.g., multiple models).

Furthermore, systems and methods according to example aspects of the present disclosure can provide for improved performance across task domains. For instance, a diversified pretraining approach according to example aspects of the present disclosure can provide for improved (e.g., more accurate, more precise, less expensive, less prone to error, etc.) processing of model inputs across task domains. For instance, in real-world deployment scenarios in which tasks may not necessarily be neatly categorized into separate domains, a model trained with a diversified pretraining approach according to example aspects of the present disclosure can provide for improved real-world performance and perform well in mixed or cross-domain tasks.

Furthermore, systems and methods according to example aspects of the present disclosure can provide for improved robustness from the diverse pretraining. For example, a model pretrained according to example aspects of the present disclosure with diverse pretraining objectives can provide for improved response in new or unfamiliar contexts based on the diverse exposure to different objectives in pretraining. For example, traditional adversarial attacks may be less effective when the model is less easily disrupted by different inputs. In this manner, additionally, for example, models pretrained with diverse objectives according to example aspects of the present disclosure can provide for improved robustness in real-world implementations in which tasks may not necessarily be neatly categorized or curated.

Furthermore, systems and methods according to example aspects of the present disclosure are well suited to pretraining transformer models. For instance, example techniques described herein provide for diverse pretraining objectives that leverage internal parallel structures and processing streams of a transformer model to attend bidirectionally over inputs to the model to recover corrupted inputs. In some embodiments, transformer models can include effectively parallelized computation of multi-headed attention. In this manner, for instance, examples of inherently parallelizable transformer models can be better pretrained for immediate deployment and/or further fine-tuning, offering improvements in scalability and distributed computation by leveraging a small number of transformer models (e.g., one transformer model) in place of many varying models (e.g., multiple models) that may not offer the same advantages at scale.

With reference now to the Figures, example embodiments of the present disclosure will be discussed in further detail.

### Example Devices and Systems

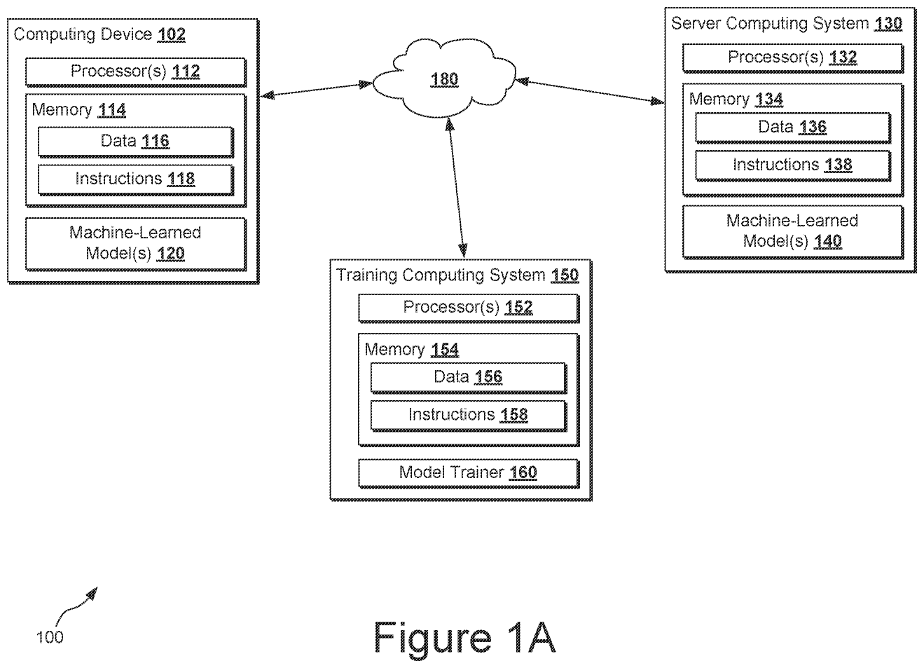

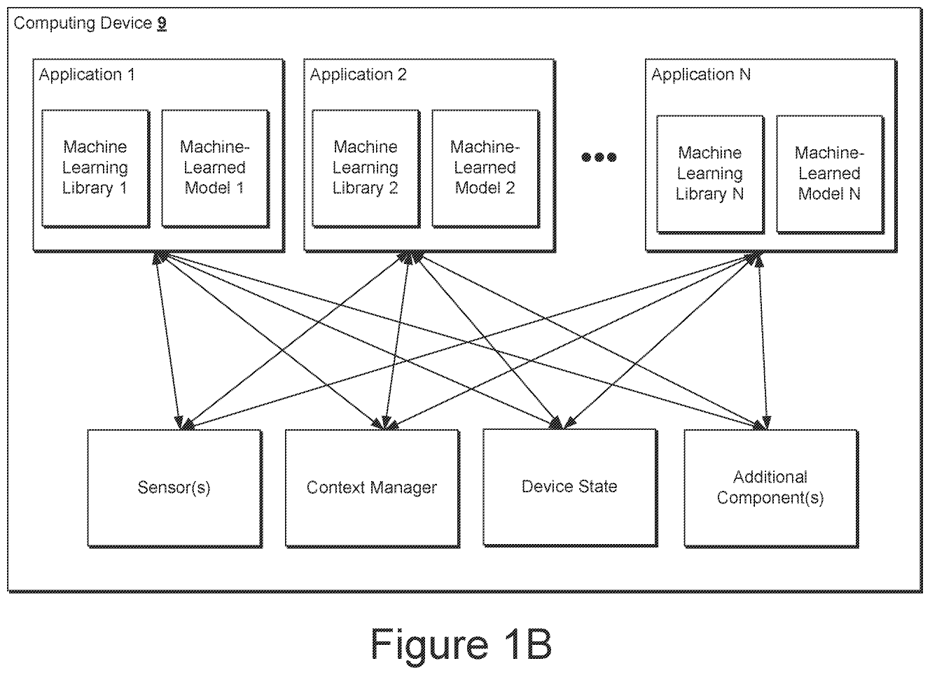

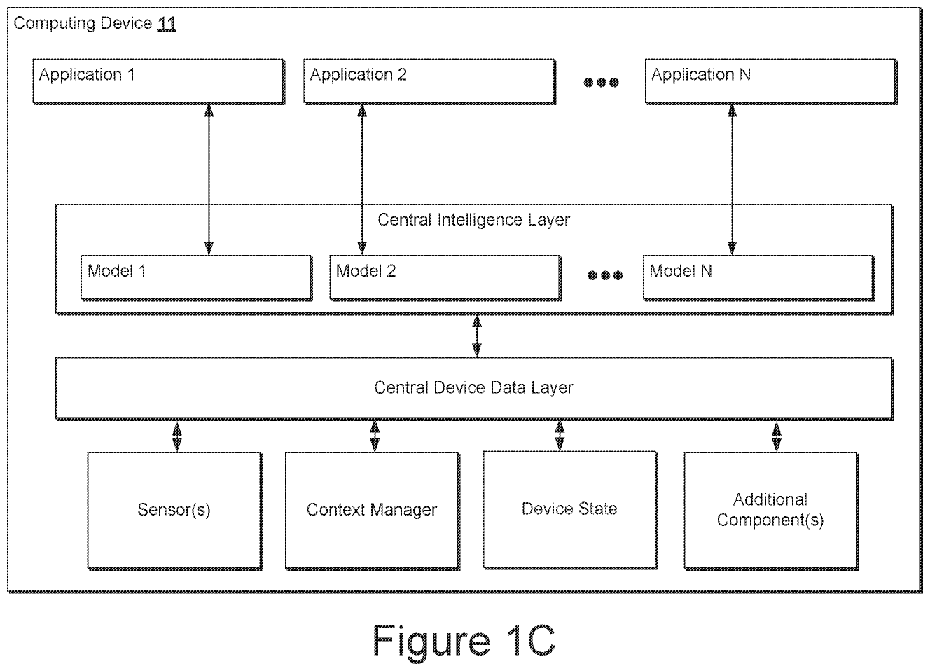

FIG. 1A depicts a block diagram of an example computing system 100 that can perform pretraining according to example embodiments of the present disclosure. The system 100 can include a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 can include one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which can be executed by the processor 112 to cause the user computing device 102 to perform operations.

In some implementations, the user computing device 102 can store or include one or more machine-learned models 120. For example, the models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more models 120 can be received from the server computing system 130 over network 180, stored in the user computing device memory 114, and then used or otherwise implemented by the one or more processors 112. In some implementations, the user computing device 102 can implement multiple parallel instances of a single model 120.

Additionally or alternatively, one or more machine-learned models 140 can be included in or otherwise stored and implemented by the server computing system 130 that communicates with the user computing device 102 according to a client-server relationship. For example, the models 140 can be implemented by the server computing system 130 as a portion of a web service (e.g., a service for processing data with the models). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 can include one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the models 120 and/or 140 based on a set of training data 162. The training data 162 can include, for example, supervised and/or unsupervised training data. In some embodiments, the training data includes sequenced data, such as sequences of data elements (e.g., textual data, such as words or other symbolic representations arranged in sequences, such as genetic information, natural language, etc.).

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general-purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output. As another example, the machine-learned model(s) can process the text or natural language data to generate a speech output (e.g., audio output).

In some implementations, the machine-learned model(s) can process the text or natural language data to generate a translation output. In some embodiments, the translation output can be in a different language than the text or natural language data. In some embodiments, the translation output can be in a different language than a set of training examples (e.g., pretraining examples). For instance, the machine-learned model(s) can provide optionally prompt-based zero-shot translation outputs.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 9 can be a user computing device or a server computing device.

The computing device 9 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 11 that performs according to example embodiments of the present disclosure. The computing device 11 can be a user computing device or a server computing device.

The computing device 11 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 11.

The central intelligence layer can communicate with a central device data layer. The central device data layer can be a centralized repository of data for the computing device 11. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Pretraining Pipeline Arrangements

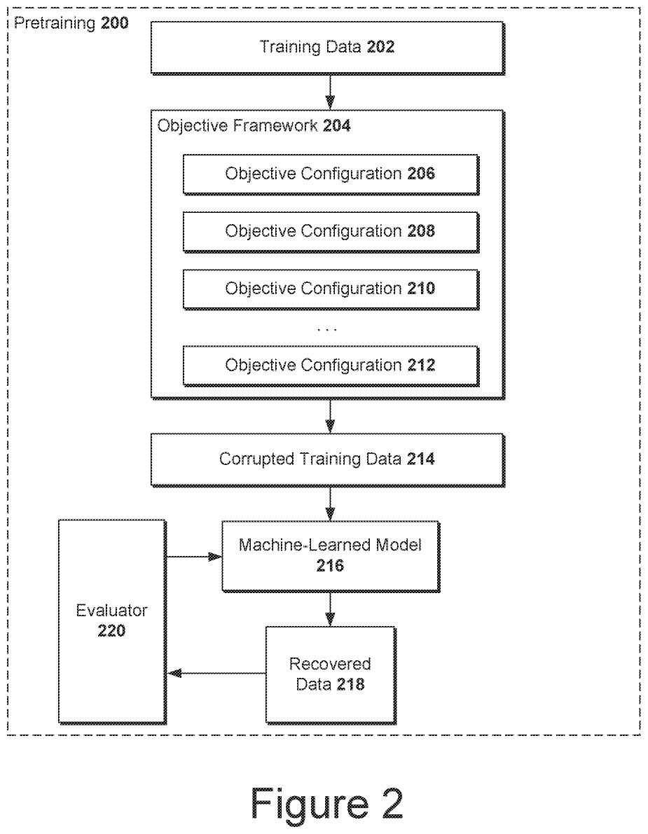

FIG. 2 depicts a block diagram of an example pretraining pipeline 200. The pretraining pipeline 200 can be configured to process training data 202 using an objective framework 204. The objective framework 204 can provide for a plurality of configurations (e.g., objective configurations 206, 208, 210, 212, etc.). Based on the plurality of objective configurations, corrupted training data 214 can be obtained for input to a machine-learned model 216 as a training example. The machine-learned model 216 can generate recovered data 218 and evaluator 220 can evaluate the performance of the machine-learned model 216 in recovering the corrupted training data 214. Based on the evaluated performance, one or more parameters of the machine-learned model 216 can be updated. In this manner, for instance, the machine-learned model 216 can be trained, such as in a pre-training iteration prior to subsequent fine-tuning training iterations.

In general, corrupted training data 214 can include both corrupted and uncorrupted aspects of the training data 202. In this manner, for instance, one or more pretraining objective(s) can include attempting to recover and/or reconstruct corrupted aspects of the training data 202, providing for an unsupervised training objective.

The machine-learned model 216 can be provided with the corrupted training data 214 to obtain as an output recovered data 218. The output recovered data 218 can be evaluated by evaluator 220 to determine one or more updates to the machine-learned model 216 (e.g., updates to one or more parameters of the machine-learned model 216).

In some embodiments, training examples of the training data 202 can include sequences of data elements (which can optionally be tokenized, such as for processing by, e.g., an encoder and/or decoder of a transformer model). In some embodiments, training examples can be subdivided into one or more subportions for generating corrupted training examples.

For example, in some embodiments, a plurality of corrupted training examples (e.g., for corrupted training data 214) can be generated from one or more training examples (e.g., of training data 202). In some embodiments, each training example of the one or more training examples includes a sequence of data tokens. In some embodiments, the plurality of corrupted training examples are respectively generated according to a plurality of configurations (e.g., objective configurations 206, 208, 210, 212, etc.) of a pretraining objective framework (e.g., objective framework 204). In some embodiments, the plurality of corrupted training examples each include one or more corrupted subportions of a sequence of data tokens.

In some embodiments, the plurality of configurations can effectively interpolate between long-range generative language modeling objectives and local prefix-based modeling objectives. Advantageously, each of the plurality of object configurations can test the performance of the model 216 in different ways. For example, bounding a model by bidirectional context (or the future) (e.g., span corruption) can make the task easier and can become more akin to fact completion. Meanwhile, language modeling objectives can be more open ended. This behaviors can be observed, for example, by monitoring cross entropy losses of different objective configurations.

In some embodiments, a modal token can be added to the input to the machine-learned model 216 to signal the mode or paradigm of pretraining. For instance, it can be beneficial for the model 216 to not only distinguish between different objective configurations during pre-training but also to adaptively switch modes when learning downstream tasks. Modal tokens can advantageously facilitate mode switching. Mode switching can include associating pre-training tasks with dedicated sentinel tokens and can allow dynamic mode switching via discrete prompting.

The objective framework 204 can provide for selection from the plurality of objective configurations based on one or more parameter values. One parameter value can include a span length parameter. The span length parameter can be a mean span length parameter. For instance, a span length for a given corrupted training example can be sampled from a desired distribution (e.g., a normal distribution) with a mean set by the span length parameter. For sequence-based objectives, the span length parameter can be augmented be constraining the span to the end of the input sequence, such that no uncorrupted tokens appear after the corrupted span.

One parameter value can include a corruption rate. A corruption rate can indicate a probability of subportions of a span being corrupted. For instance, a corruption rate can be expressed as a percentage, fraction, etc.

One parameter value can include a quantity of spans. The quantity of spans can be a function of the length of the original input. The quantity of spans can be a function of the span length or mean span length. For instance, the quantity of spans can be determined based on computing the result of the input length divided by the span length.

Parameterizing the objective framework based on the span length, corruption rate, and quantity of spans can provide for multiple different objective configurations that can interpolate among different types of learning objectives. As an example, to construct an objective analogous to causal language modeling using this formulation, one could set the span length to the length of the input span, a corruption rate of 100%, and the quantity of spans to 1 (e.g., a single corrupted span with its span length equal to the length of the input sequence). To express one similar to prefix-based language modeling objective, one could set the span length to the difference between the input sequence length and a prefix length and the quantity of spans to a single, post-prefix span, with the additional constraint that the single corrupted span reaches the end of the sequence. The corruption rate can be set at, for example 100% minus the ratio of the prefix length to the input span length.

Multiple different objective configurations can be used. For instance, a first objective configuration can be used for training example. A second objective configuration can be used for a second training example. A third objective configuration can be used for a third training example. Alternatively, multiple different objective configurations can be used for each training example.

An example mixture of objective configurations is described herein with respect to three different types or classes of configurations. The first two types or classes of configurations that follow can be considered distributed configurations, in that they can be configured for generating multiple corrupted spans distributed across the input sequence (e.g., randomly distributed). The third type or class can be considered a sequential configuration, in that it can be configured for generating a corrupted span in a particular sequence (e.g., a sequence of uncorrupted input followed by a single span of corrupted input).

A first objective configuration can be a configuration that implements relatively short corrupted spans. The first objective configuration can include relatively short corrupted spans with relatively low corruption rates. The first objective configuration can be similar to “regular” span corruption objectives, such as introduced by Colin Raffel, Noam Shazeer, Adam Roberts, Katherine Lee, Sharan Narang, Michael Matena, Yanqi Zhou, Wei Li, & Peter J Liu, Exploring the limits of transfer learning with a unified text-to-text transformer, arXiv preprint arXiv: 1910.10683, 2019. An example first objective configuration can include parameters to use about 2 to 5 tokens as the span length, or less than about 10 tokens, and corrupting about 15% of input tokens. A first objective configuration can be a mild corruption configuration.

A second objective configuration can be a configuration that implements more extreme corruption. The second objective configuration can include longer spans for corruption. The second objective configuration can include higher corruption rates. For instance, an example second objective configuration can include spans for corruption of length greater than about 12 tokens. In some examples, approximately half the input can be portioned apart for corruption. An example second objective configuration can include a corruption rate of greater than about 30%, such as about 50% or greater.

A third objective configuration can be a configuration that implements relatively long-form language generation. The third objective configuration can be a sequence-based objective. The third objective configuration can be set up to provide for a predetermined sequential ordering of uncorrupted and corrupted spans. For instance, the third objective configuration can provide a prefix-based language modeling task. The third objective configuration can partition the input sequence into two sub-sequences of tokens as context and target such that the targets do not rely on future information.

A pretraining pipeline 200 can leverage any one or more of objective configurations from the three different classes. A pretraining pipeline 200 can implement all three classes of objective configurations. A pretraining pipeline 200 can implement one or more objective configurations from each of the three classes. For instance, multiple sets of configuration parameters can be used within each class. For instance, the mild class of objectives can be implemented with a span length of three and a span length of 8 together (e.g., in parallel), both with a corruption rate of 15%. The more extreme class of objectives can be implemented with a span length of three, a span length of 8, a span length of 64 (all with a corruption rate of 50%) and a span length of 64 with a corruption rate of 15%. The sequence-based class of objectives can be configured with a variety of span lengths, such as one-quarter of the input sequence length, with a corruption rate of 25%. In this manner, for instance, each class can be implemented in different configurations in parallel to train model 216. For instance, all seven of the examples provided above can be used during training of model 216.

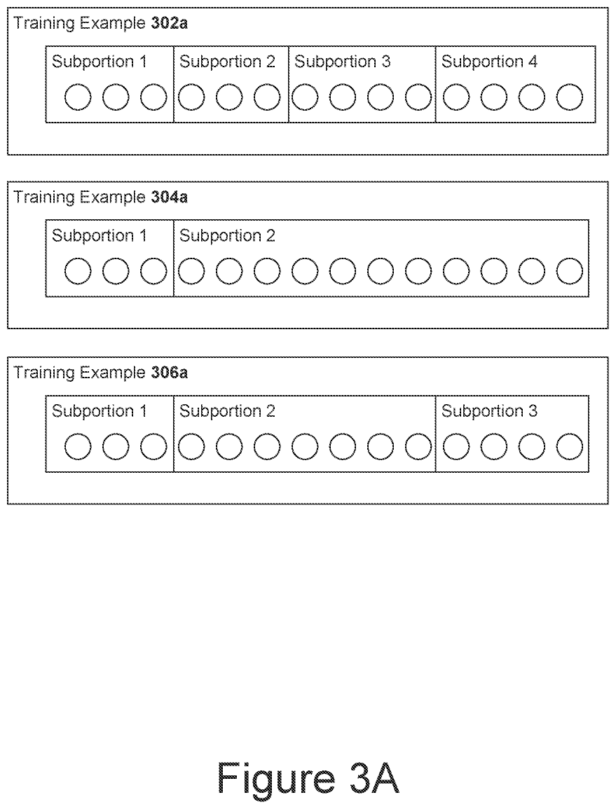

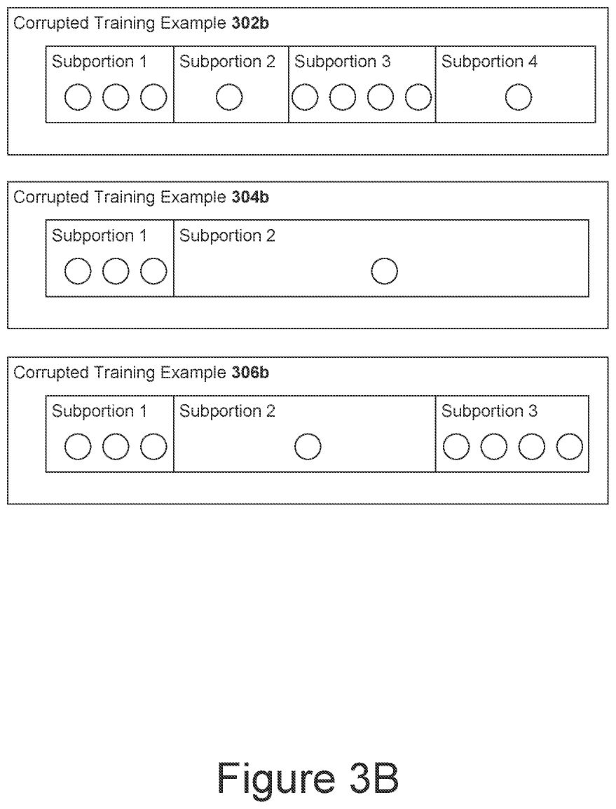

In FIG. 3A, a block diagram of training examples 302a, 304a, and 306a illustrates a plurality of training examples subdivided into subportions. The subportions each contain one or more data elements (e.g., tokens). According to the plurality of configurations (e.g., objective configurations 206, 208, 210, 212, etc.), one or more subportions of the training examples 302a, 304a, 306a, can be selected for corruption. For instance, the training examples can be subdivided based on a configuration parameter of the objective framework characterizing a count of subportions and/or characterizing a span length of subportions (e.g., a quantity of tokens/elements for a subportion). Once one or more subportions are selected for corruption, a corruption rate configuration parameter can characterize a likelihood of the subportion being corrupted.

FIG. 3B depicts a plurality of corrupted training examples 302b, 304b, 306b. The corrupted training examples 302b, 304b, and 306b can be derived from the same or different uncorrupted training examples from the training data 202 (e.g., optionally corresponding to training examples 302a, 304a, 306a). Each of the corrupted training examples 302b, 304b, and 306b can include one or more selected subportions for corruption. In some embodiments, at least one subportion of each of the corrupted training examples 302, 304, and 306 can be corrupted. For instance, subportions 2 and 4 of corrupted training example 302 might be corrupted (although other subportions can also be corrupted in addition to or instead of subportions 2 and 4). For instance, subportion 2 of corrupted training example 304 might be corrupted (although other subportions can also be corrupted in addition to or instead of subportion 2). For instance, subportion 2 of corrupted training example 306 might be corrupted (although other subportions can also be corrupted in addition to or instead of subportion 2). As illustrated, in some embodiments, a corrupted subportion can be replaced with a corrupted token (e.g., optionally a distinct token for each corrupted subportion).

In this manner, for example, the machine-learned model 216 can learn to recover the corrupted subportions by processing the corrupted subportions (e.g., processing replacement or altered token(s) for the subportion).

Corrupted training examples 302, 304, and 306 can be corrupted according to the same objective configuration. Each of corrupted training examples 302, 304, and 306 can be corrupted according to different objective configurations. Each of corrupted training examples 302, 304, and 306 can be corrupted according to a battery of objective configurations, such as each of a set of configurations.

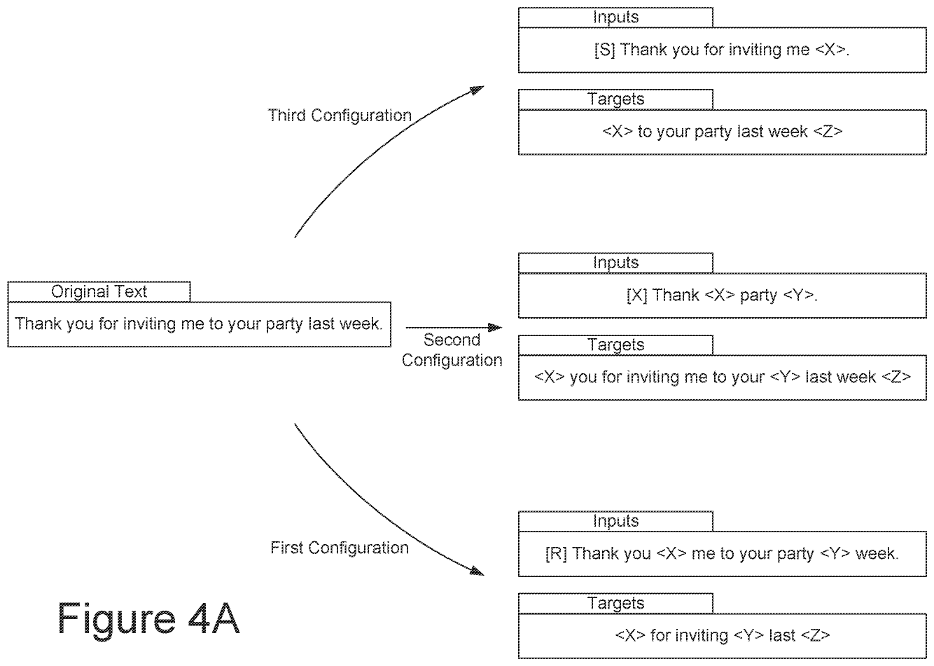

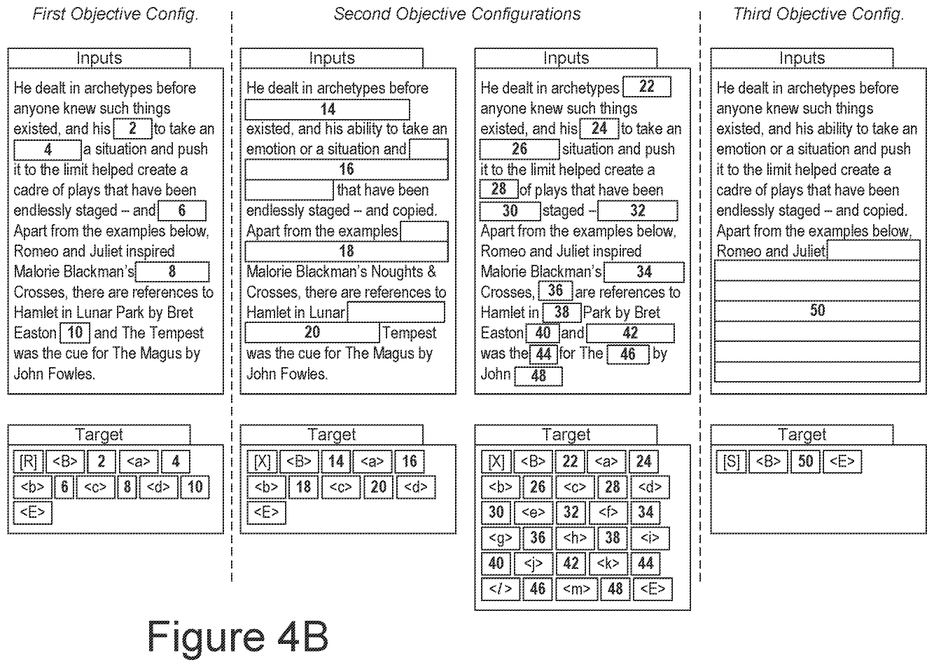

FIG. 4A depicts one illustration of how a training example can be broken out into a plurality of corrupted training examples based on a plurality of configurations of an objective framework.

Under a first objective configuration, for instance, original text “Thank you for inviting me to your party last week” can be corrupted as “Thank you <X> me to your party <Y> week” where <X> and <Y> are optionally distinct replacement tokens, such that the machine-learned model can target obtaining “for inviting” for and “last” for <Y>. This can be can example of a mild objective configuration.

In a second, more extreme objective configuration, for instance, the original text can be corrupted as “Thank <X> party <Y>” where <X> and <Y> are optionally distinct replacement tokens, such that the machine-learned model can target obtaining “you for inviting me to your” for <X> and “last week” for <Y>.

In a third objective configuration, the original text can be corrupted as “Thank you for inviting me <X>.” where <X> is a replacement token, such that the machine-learned model can target obtaining “to your party last week” for <X>. This can be an example of a prefix-based language modeling objective.

In some embodiments, configuration parameters of the objective framework can be selected to interpolate between, for example, language modeling objectives (e.g., to unidirectionally predict subsequent word(s) based on preceding word(s)) and in-place reconstruction (e.g., fill in gaps bidirectionally based on surrounding context). For instance, as the corrupted subportion length increases, the objective can, in some embodiments, approximate a language modeling objective locally within the corrupted subportion. Accordingly, a diverse mixture of pretraining objectives can be generated by implementing a plurality of configurations of a pretraining objective framework according to example aspects of the present disclosure.

In some embodiments, a modal token can be added to the input to the machine-learned model 216 to signal the mode or paradigm of pretraining. For instance, in FIG. 4A, “[R]” can indicate a modal token indicating a “regular” or “mild” class objective. “[X]” can indicate a modal token indicating a more extreme class objective. “[S]” can indicate a modal token indicating a sequence-based language modeling objective. The modal tokens can be used during pretraining, during fine-tuning, and during downstream tasks. In this manner, for instance, “mode-switching” can be invoked at inference time to engage a relevant operational mode of the trained model.

FIG. 4B illustrates an example application of a mixture of objective configurations to the same input sequence. For a first objective configuration, relatively few subportions 2, 4, 6, 8, and 10 are selected for corruption. As shown in FIG. 4B, the target for prediction by model 216 is initiated with the modal token “[R]” indicating a regular or more mild class of objective configuration. For instance, the mean span length of the subportions 2, 4, 6, 8, and 10 can be, for instance, around 5. Sampled span lengths can be, in one example, 3, 5, 4, 5, and 2, respectively.

The symbols “< {letter}>” can be all the same or individually selected (e.g., individually different) and can be used to index the subportions 2, 4, 6, 8, and 10. For instance, the target can be input to the model 216 (e.g., to a decoder component of the model) to trigger prediction of the original tokens corresponding to the corrupted spans indicated in the target. For instance, a placeholder token “<a>” can be associated (e.g., distinctly associated) with subportion 4. The input can include a placeholder token corresponding to “<a>” in lieu of the subportion 4. Thus the model 216 can be configured to predict based on processing “<a>” that subportion 4 follows. Accordingly, the target can be used to guide the model 216 toward predicting an output sequence that contains the corrupted subportions delimited by the corresponding placeholder token(s). For instance, for the first objective configuration, an example output can be “<B> ability <a> emotion or <b> copied. <c>Noughts & <d> Ellis, <E>.” In this manner, for instance, example implementations can effectively provide a fill-in-the-blank solution to masked-out subportions of the input sequence.

For a second objective configuration, multiple sets of configuration parameters can be used. For instance, in a first set of configuration parameters (left column), the mean span length can be longer (e.g., 20 tokens, 30 tokens, 40 tokens, etc.). The span quantity can be relatively low. For instance, spans 14, 16, 18, and 20 can be selected for corruption. Individual sampled span lengths can be, in one example, 16, 32, 24, and 24, respectively. In a second set of configuration parameters (right column), the mean span length can be shorter (e.g., 3 tokens, 5 tokens, 8 tokens, etc.). The span quantity can be relatively higher. For instance, spans 22, 24, 26, 28, 30, 32, 34, 36, 38, 40, 42, 44, 46, and 48 can be selected for corruption. Individual sampled span lengths can be, in one example, 3, 3, 5, 4, 4, 5, 5, 3, 3, 2, 4, 4, 2, 4, and 5, respectively. As shown in FIG. 4B, the target for this example configuration is initiated with the modal token “[X]” indicating a more extreme class of objective configuration.

For a third objective configuration, a sequence-based objective can be used. A single, longer span 50 can be selected for corruption. For instance, the span length can be 95. The span can be anchored to the end of the input sequence. As shown in FIG. 4B, the target for this example configuration is initiated with the modal token “[S]” indicating a sequence-based class of objective configuration.

### Example Results

For pre-training objectives, a Present Example is compared with the following pre-training baselines:
Causal Language Model (CLM)—This is the standard left-to-right auto-regressive language model pre-training, used in many standard pre-trained models, like GPT (Radford et al., 2019; Brown et al., 2020). This disclosure refers to this model as GPT-like in the experiments.
Prefix LM (PLM)—This is a slight variation of causal LM where M has bidirectional receptive fields, introduced in (Liu et al., 2018; Raffel et al., 2019). For this baseline, PLM is uniformly sampled for the length of M and only compute the loss at the auto-regressive targets.
Span Corruption (SC)—This is the standard denoising objective proposed in T5 (Raffel et al., 2019). The idea is to blank out certain text portions and replace them with sentinel tokens. The text replaced with sentinel tokens are then copied to the targets and autoregressively generated by the model. This baseline uses a mean span of 3 and denoising rate of 15% following the default T5 setup.
Span Corruption+LM (SCLM)—This baseline trains on a mixture of CLM and Span Corruption with an equal mix ratio. This baseline uses the same hyper-parameters for SC for the SC component of this objective.
UniLM (ULM)—This is the objective proposed in Dong et al. (2019).

For all objectives, these results explore both single-stack and encoder-decoder architectures. All architectures are inputs-to-targets either implemented in encoder-decoder or decoder-only model structures since we consider BERT-style masked language modeling pretraining to have already been effectively subsumed by this style of pretraining, as empirically made evident in (Raffel et al., 2019).

The datasets used are SuperGLUE (Wang et al., 2019), including 8 NLU sub-tasks. Experiments also cover 3 datasets from the GEM benchmark (Gehrmann et al., 2021) that focuses on language generation problems. XSUM (summarization), ToTTo (table-to-text generation) (Parikh et al., 2020) and Schema Guided Dialog (SGD) (Rastogi et al., 2019) from the GEM benchmark are used. For all these tasks, these results evaluate on both supervised fine-tuning and prompt-based one-shot learning. Finally these results also compare the models on their general ability for text generation using perplexity scores on the C4 validation set.

For SuperGLUE, these results report well-established metrics such as accuracy, F1 or Exact Match, whenever appropriate. For GEM benchmark, these results use the Rouge-L metric. For language modeling these results report negative log perplexity. The universality of the models, i.e., their collective performance across all range of tasks, is a main evaluation criteria here. To enable the comparison between models from this perspective, these results use an aggregate performance score. However, metrics on different tasks can be widely different in nature-take, for example, F1 and perplexity. To address this, these results opt to report and use the normalized relative gain with respect to baselines as an overall metric. For this purpose, these results use the standard language model (decoder-only) (GPT-like) and standard span denoising encoder-decoder (T5) as prime baselines and report all methods against their relative performance against these well-established candidates. The overall gain is normalized for these results, so this becomes harder to exploit or be susceptible to benchmark lottery effects.

The present experiments are all conducted in JAX/Flax (Bradbury et al., 2018) using the open source T5X4 framework (Roberts et al., 2022) and Flaxformer. The present experiments pre-train all models for 500K steps with a batch size of 128 and a sequence length of 512 inputs and 512 targets using the C4 corpus. The total approximate tokens seen during pre-training is approximately 32 billion tokens. Each pre-training run is typically trained using 64 to 128 TPUv4 chips (Jouppi et al., 2020).

The present experiments optimize the Present Example with the Adafactor (Shazeer & Stern, 2018) optimizer with an inverse square root learning rate. The present example runs all baseline pre-training objectives with both the decoder-only architecture and encoder-decoder architecture. The present results report key experiment results using a base architecture of approximately 167M parameters for the decoder model and 335M parameters for the encoder-decoder model. All models use a standard Transformer that uses SwiGLU layers as described in (Shazeer, 2020).

The present examples use the default T5 English 32K sentence piece for all models. Within the context of decoder-only models, except for the case of the decoder model trained on causal LM, the present experiments use a bidirectional receptive field only in its input segment and autoregressive decoding at the targets segment.

Table 1 reports the raw results on all the benchmark tasks and datasets. The Present Example is denoted by “UL2.” To facilitate easier comparison across setups, the present results also report relative comparisons against well-established baselines such as T5 and GPT models. This is reported in Tables 2 and 3 respectively.

TABLE 1
Example results. All models trained on 32B parameters.

| | | | Supervised Finetuning | | | | In-context One-shot | | | | |
|---|---|---|---|---|---|---|---|---|---|---|---|
| Obj | Arch | Params | SG | XS | SGD | TOT | SG | XS | SGD | TOT | LM |
| CLM | Dec | 167M | 62.24 | 28.18 | 55.44 | 59.40 | 39.22 | 1.16 | 1.40 | 0.20 | −2.35 |
| PLM | Dec | 167M | 62.44 | 28.21 | 55.55 | 59.52 | 42.54 | 1.08 | 3.70 | 6.40 | −2.54 |
| SC | Dec | 167M | 67.67 | 29.14 | 55.48 | 60.47 | 38.53 | 1.16 | 2.20 | 1.60 | −3.62 |
| SCLM | Dec | 167M | 63.36 | 29.02 | 55.71 | 60.00 | 40.78 | 3.03 | 1.27 | 0.10 | −2.38 |
| UL2 | Dec | 167M | 65.50 | 28.90 | 55.80 | 60.39 | 42.30 | 8.01 | 6.30 | 5.80 | −2.34 |
| PLM | ED | 335M | 69.30 | 31.95 | 55.70 | 60.91 | 38.18 | 6.50 | 7.11 | 3.90 | −2.42 |
| SC | ED | 335M | 72.00 | 31.05 | 55.80 | 61.25 | 38.51 | 7.49 | 1.43 | 2.10 | −7.23 |
| SCLM | ED | 335M | 72.50 | 31.69 | 55.70 | 60.94 | 39.74 | 5.13 | 8.70 | 7.30 | −2.40 |
| UniLM | ED | 335M | 71.10 | 31.00 | 55.83 | 61.03 | 39.86 | 6.70 | 6.50 | 4.10 | −2.65 |
| UL2 | ED | 335M | 73.10 | 31.86 | 56.10 | 61.50 | 41.30 | 11.51 | 6.63 | 6.50 | −2.55 |

TABLE 2
Results in this table are expressed in terms of relative percentage improvements
over a baseline. Model with star denotes the main compared baseline. Overall
score column is normalized to be weighted equally across tasks.

| | | Supervised | | | | One-shot | | | | | | |
|---|---|---|---|---|---|---|---|---|---|---|---|---|
| Obj | Arch | SG | XS | SGD | TOT | SGL | XS | SGD | TOT | LM | All | Win |
| CLM | Dec | −13.6 | −9.2 | −0.7 | −3.0 | +1.8 | −91.7 | −2.2 | −90.5 | +208 | −31.7 | 2/9 |
| PLM | Dec | −13.3 | −9.2 | −0.5 | −2.8 | +10.5 | −85.6 | +158 | +205 | +185 | −11.0 | 4/9 |
| SC | Dec | −5.6 | −6.2 | −0.6 | −1.3 | +0.05 | −84.5 | +54 | −23.8 | +99 | −20.6 | 3/9 |
| SCLM | Dec | −6.0 | −6.5 | −0.2 | −2.0 | +5.9 | −59.6 | −11.3 | −95 | +204 | −16.1 | 2/9 |
| UniLM | Dec | −10.1 | −8.2 | −0.2 | −2.3 | −5.3 | −69.1 | +382 | +110 | +200 | −16.1 | 3/9 |
| UL2 | Dec | −9.0 | −6.9 | 0.0 | −1.4 | +9.8 | +6.9 | +340 | +176 | +209 | +14.1 | 5/9 |
| PLM | ED | −3.7 | +2.9 | −0.2 | −0.6 | −0.86 | −13.3 | +397 | +86 | +199 | +16.7 | 5/9 |
| SC* | ED | 0.0 | 0.0 | 0.0 | 0.0 | 0.0 | 0.0 | 0.0 | 0.0 | 0.0 | 0.0 | — |
| SCLM | ED | +0.7 | +2.1 | −0.2 | −0.5 | +3.2 | −31.6 | +508 | +248 | +201 | +28.3 | 7/9 |
| UniLM | ED | −1.2 | −0.2 | +0.1 | −0.4 | +3.5 | −11.0 | +355 | +95 | +173 | +19.8 | 5/9 |
| UL2 | ED | +1.5 | +2.6 | +0.5 | +0.4 | +7.2 | +53.6 | +363 | +210 | +184 | +43.6 | 9/9 |

TABLE 3
Relative performance compared to standard decoder causal language model (GPT-like).
Results in this table are expressed in terms of relative percentage improvements over a
baseline. Model with star denotes the main compared baseline. Overall score column is
normalized to be weighted equally across tasks.

| | | Supervised | | | | One-shot | | | | | | |
|---|---|---|---|---|---|---|---|---|---|---|---|---|
| Obj | Arch | SG | XS | SGD | TOT | SG | XS | SGD | TOT | LM | All | Win |
| CLM* | Dec | 0.0 | 0.0 | 0.0 | 0.0 | 0.0 | 0.0 | 0.0 | 0.0 | 0.0 | 0.0 | — |
| PLM | Dec | +0.3 | +0.1 | +0.2 | +0.2 | +8.5 | +74.3 | +164 | +3100 | −8.0 | +21.4 | 8/9 |
| UniLM | Dec | +4.0 | +1.1 | +0.5 | +0.7 | −7.0 | +274 | +393 | +2100 | −2.5 | +21.0 | 7/9 |
| SC | Dec | +8.7 | +3.4 | +0.1 | +1.8 | −1.8 | +87.0 | +57.1 | +700 | −54.2 | +13.9 | 7/9 |
| SCLM | Dec | +1.8 | +3.0 | +0.5 | +1.0 | +4.0 | +387 | −9.3 | −50 | −1.3 | +15.8 | 6/9 |
| UL2 | Dec | +5.2 | +2.6 | +0.6 | +1.7 | +7.9 | +1190 | +350 | +2800 | +0.3 | +45.7 | 9/9 |
| PLM | ED | +11.3 | +13.4 | +0.5 | +2.5 | −2.6 | +946 | +408 | +1850 | −2.9 | +48.6 | 7/9 |
| SC | ED | +16.5 | +10.2 | +0.6 | +3.1 | −1.8 | +1107 | +2.3 | +950 | −208 | +31.7 | 7/9 |
| SCLM | ED | +15.7 | +12.5 | +0.5 | +2.6 | +1.3 | +726 | +522 | +3550 | −2.2 | +60.3 | 8/9 |
| UniLM | ED | +14.2 | +10.0 | +0.7 | +2.7 | +1.6 | +974 | +365 | +1950 | −12.9 | +52.6 | 8/9 |
| UL2 | ED | +17.4 | +13.1 | +1.2 | +3.5 | +5.3 | +1754 | +373 | +3150 | −8.3 | +76.1 | 8/9 |

When using T5 as the reference baseline, with the exception of UL2 Decoder, none of the pre-trained decoders models outperform T5. Additionally, there is a 10% to 30% degradation in overall relative performance. The Prefix-LM decoder model is about 10% worse than the T5 baseline. The UL2 decoder outperforms the T5 encoder-decoder setup by +14.6%.

Overall, UL2 outperforms by T5 +43.4% and +76.2% when compared to the GPT-like CLM decoder model. This is the highest relative (overall) gain compared to all other alternatives. On all individual tasks, UL2 outperforms T5 on all 9 out of 9 considered tasks. Hence, UL2 is a universally better option compared to the span corruption T5 model. UL2 is very consistent. Even when it loses to another method on a task, the loss is relatively marginal (e.g., 6.5 vs 7.3 on one-shot TOTTO). Conversely, when UL2 outperforms a baseline like T5, the gain can be as large as +363%. UL2 remains the most consistently strong method. The consistent improvement also suggests that it can be used as a more consistent replacement to T5 and GPT-like models.

In order to ascertain that mode switching capabilities can be effective on performance, ablation results are provided. Experiments on one-shot XSum and one-shot SuperGLUE were conducted. Table 4 reports the results of varying the paradigm prompt to the model. The results show that using the right or wrong prompt can lead to a 48% gap in performance (on XSum, Rouge-1). SuperGLUE, on the other hand, was less sensitive to prompting. On SuperGLUE, using prompts was almost always better than not using prompts during one-shot evaluation.

TABLE 4
Effect of different paradigm prompts on 1-shot evaluation, using a
Encoder-Decoder architecture pre-trained using UL2 on 7B tokens.

| Model/Prompt | 1Shot XSum | 1Shot SuperGLUE |
|---|---|---|
| Baseline T5 | 6.9/0.6/6.1 | 33.9 |
| UL2/None | 13.2/1.4/10.8 | 38.3 |
| UL2/[R] | 13.5/1.5/11.1 | 38.5 |
| UL2/[S] | 11.6/1.2/10.0 | 38.5 |
| UL2/[X] | 8.9/0.9/7.6 | 38.7 |

TABLE 5
Ablation study. Span, Rate and SD are in percentages
(%). SuperGLUE score (SG) and XSUM Rouge-L (XS).

| | Ablation Method | | | Supervised | | One-shot | |
|---|---|---|---|---|---|---|---|
| Name | Span (μ) | Rate (r) | SD % | SG | XS | SG | XS |
| A | — | — | 100 | 69.3 | 31.1 | 38.2 | 6.5 |
| B | 3 | 50 | 0 | 72.0 | 32.0 | 38.5 | 7.5 |
| C | 3, 8, 12 | 15, 50 | 14 | 71.9 | 32.1 | 38.6 | 4.1 |
| D | 3, 8, 12, 32 | 15, 50 | 11 | 71.0 | 32.2 | 42.7 | 10.6 |
| E | 3, 8, 32, 64 | 15, 50 | 11 | 73.1 | 32.2 | 40.7 | 10.4 |
| F | 3, 8, 64 | 15, 50 | 17 | 70.6 | 31.6 | 41.3 | 11.5 |
| G | 3, 8, 32, 64 | 15 | 25 | 69.2 | 31.6 | 42.4 | 10.1 |
| H | 8, 64 | 15 | 25 | 72.5 | 31.2 | 39.2 | 10.9 |
| I | 3, 8, 12, 32 | 15, 50 | 50 | 71.2 | 32.0 | 38.1 | 11.7 |
| J | 3, 8, 64 | 15, 50 | 50 | 71.3 | 31.6 | 38.1 | 11.8 |
| K | 3, 8, 12 | 15, 50 | 0 | 73.7 | 32.0 | 39.3 | 2.6 |
| L | 3, 8, 64 | 15, 50 | 0 | 70.1 | 32.1 | 38.0 | 7.3 |

Experiments are provided to test the effectiveness of individual objectives within the objective framework. Table 5 reports results for these ablations. Table 5 reports results for varying the mean span, and corruption rate, along with the percentage of S-denoising used (denoted by % SD)). For this test, the total number of configurations in a mixture was span×corruption rate+1. Table 5 labels these configurations from Var-A through Var-L to refer to them easily.

Additional experiments are conducted by scaling up both 1) the model size and 2) pre-training dataset size. The UL2 Encoder-Decoder model was scaled up to approximately 1B parameters and increased the number of pre-training tokens to 0.5 trillion tokens.

Table 6 reports results in this scaled setting. At large scale, the Present Example UL2 encoder-decoder model is still competitive. A difference now is that UL2 drops the SuperGLUE suite against T5 (1B). However, this is compensated by not only out-performing on 7 out of 8 tasks but also improving performance by 2-4 times on one-shot evaluation. The gains on supervised fine-tuning are smaller, but still noticeable across the board on XSUM, SGD and TOT.

TABLE 6
Experiments with moderately scaled up models in terms of model compute (e.g.,
1B for EncDec and 0.5B for decoder-only) and dataset size (0.5T tokens).

| | Finetuning | | | | In-context Learning | | | |
|---|---|---|---|---|---|---|---|---|
| Model | SG | XS | SGD | TOT | SG | XS | SGD | TOT |
| GPT-like | 62.3 | 37.1/15.7/30.2 | 56.0 | 60.3 | 36.4 | 1.2/0.1/1.1 | 3.5 | 0.0 |
| T5 | 84.7 | 43.0/20.8/35.6 | 56.0 | 62.1 | 29.4 | 8.9/0.8/7.8 | 2.1 | 1.4 |
| UL2 | 83.3 | 43.3/21.0/35.9 | 56.5 | 62.6 | 45.4 | 15.4/2.5/11.1 | 9.6 | 7.8 |

The Present Example was also evaluated at a model size of about 20B parameters. The present experiments follow the same training protocol in earlier experiments by pretraining on the C4 corpus but by also scaling the number of tokens the model sees during pretraining. The present experiments use a batch size of 1024 and 512 TPUv4 chips for pretraining this model. The model is trained on a total of 1 trillion tokens on C4 (2 million steps). The sequence length is set to 512/512 for inputs and targets. Dropout is set to 0 during pretraining. The model has 32 encoder layers and 32 decoder layers, dmodel of 4096 and dff of 16384. The dimension of each head is 256 for a total of 16 heads. The model uses a model parallelism of 8. The results retain the same sentence piece tokenizer as T5 of 32 k vocab size. Hence, UL20B can be interpreted as a model that is quite similar to T5 but trained with a different objective and slightly different scaling knobs. Similar to earlier experiments, UL20B is trained with Jax and T5X infrastructure.

To demonstrate the universality of the approach, the present experiments consider a total of nearly 50+ NLP tasks. The list and categorization of tasks is below. Note that the categorization of tasks are generally soft in nature and some tasks may cross into different categorization boundaries.

Language Generation-summarization and data-to-text generation tasks. CNN/Dailymail (Hermann et al., 2015), XSUM (Narayan et al., 2018), MultiNews (Fabbri et al., 2019), SAMSum (Gliwa et al., 2019), WebNLG (Castro Ferreira et al., 2020) (English), E2E (Dusek et al. ̌, 2019) and CommonGen (Lin et al., 2020) to evaluate our models. For WebNLG, E2E and CommonGen, use the versions from the GEM benchmark (Gehrmann et al., 2021).

Language Generation with Human Evaluation-evaluate on a variety of text generation tasks using human evaluation, via the GENIE leaderboard (Khashabi et al., 2021). These tasks include aNLG (Bhagavatula et al., 2019), ARC-DA (Clark et al., 2018), WMT19 (Foundation), and XSUM (Narayan et al., 2018).

Language Understanding, Classification and Question Answering-use Reading Comprehension, Question Answering, Text Classification and natural language inference datasets. Use RACE (Reading comprehension) (Lai et al., 2017), QASC (Khot et al., 2020), OpenBookQA (Mihaylov et al., 2018), TweetQA (Xiong et al., 2019), QuAIL (Rogers et al., 2020), IMDB (Maas et al., 2011), Agnews (Zhang et al., 2015), DocNLI (Yin et al., 2021), Adversarial NLI (Nie et al., 2019), VitaminC (Schuster et al., 2021a), Civil Comments and Wikipedia Toxicity detection datasets (Borkan et al., 2019). Use standard SuperGLUE (Wang et al., 2019) and GLUE (Wang et al., 2018) datasets.

Commonsense Reasoning-use HellaSwag (Zellers et al., 2019), SocialIQA/SIQA (Sap et al., 2019), PhysicalIQA/PIQA (Bisk et al., 2020), CosmosQA (Huang et al., 2019), AbductiveNLI (Bhagavatula et al., 2019), CommonsenseQA (Talmor et al., 2018), CommonsenseQA2 (Talmor et al., 2021).

Long Range Reasoning-Use the Scrolls benchmark (Shaham et al., 2022) which comprises of seven component tasks including GovReport (Huang et al., 2021), SumScr (Chen et al., 2021), QMSUm (Zhong et al., 2021), QASPER (Dasigi et al., 2021), NarrativeQA (Kocisk ̌ y et al.′, 2018), QuaLITY (Pang et al., 2021), and ContractNLI (Koreeda & Manning, 2021).

Structured Knowledge Grounding—use several component tasks from UnifiedSKG (Xie et al., 2022), namely WikiTQ (Pasupat & Liang, 2015), CompWQ (Talmor & Berant, 2018), FetaQA (Nan et al., 2021), HybridQA (Chen et al., 2020), WikiSQL (Zhong et al., 2017), TabFat (Chen et al., 2019), Feverous (Aly et al., 2021), SQA (Iyyer et al., 2017), MTOP (Li et al., 2020) and DART (Nan et al., 2020). Select datasets that are relatively convenient to perform evaluation and uses mainstream metrics such as accuracy or exact match instead of obscure ones or those that require significant domain specific post-processing.

Information Retrieval-IR is the task of retrieving relevant documents given queries. Use the setup of the latest next generation IR paradigm, i.e., differentiable search index (Tay et al., 2022) for the experiments. Use the same NQ (Kwiatkowski et al., 2019) splits in the DSI paper.

For each dataset, the best previous state of the art (SOTA) result is provided.

TABLE 7
Summary of UL20B results compared to state-of-the-art.

| Dataset | Metric | Eval | Sota Reference | SOTA | Ours |
|---|---|---|---|---|---|
| CNN/DM | Rouge-2 | Test | Zoph et al. | 21.7 | 21.9 |
| XSUM | Rouge-2 | Test | Zoph et al | 27.1 | 26.6 |
| MultiNews | Rouge-2 | Test | Xiao et al. | 21.1 | 21.7 |
| SAMSum | Rouge-2 | Test | Narayan et al. | 28.3 | 29.6 |
| Gigaword | Rouge2 | Test | Aghajanyan et al. | 20.7 | 20.7 |
| WebNLG (en) | Rouge-2 | Test | Bakshi et al. | 53.5 | 55.4 |
| E2E-NLG | Rouge-2 | Test | Xue et al. | 45.8 | 46.5 |
| CommonGen | Rouge-2 | Dev | Gehrmann et al. | 32.5 | 37.4 |
| Schema-Guided | Rouge-2 | Test | Gehrmann et al. | 36.8 | 44.1 |
| Dialog | | | | | |
| GENIE-aNLG | Human (H) | Test | Khashabi et al | 76.0 | 77.0^{(l)} |
| GENIE - ARC-DA | Human | Test | Khashabi et al | 72.0 | 72.0^{(l)} |
| (w/o IR) | | | | | |
| GENIE-WMT19 | Human | Test | Khashabi et al. | 71.0 | 67.0^{(l)} |
| GENIE-XSUM | H-Overall | Test | Clive et al. | 51.0 | 50.0^{(l)} |
| GENIE-XSUM | H-Concise | Test | Clive et al. | 53.0 | 53.0^{(l)} |
| GENIE-XSUM | H-Fluency | Test | Clive et al. | 51.0 | 52.0^{(l)} |
| GENIE-XSUM | H-No-Hallucination | Test | Clive et al. | 53.0 | 54.0^{(l)} |
| GENIE-XSUM | H-Informativeness | Test | Clive et al. | 49.0 | 49.0^{(l)} |
| SIQA | Accuracy | Test | Lourie et al. | 83.2 | 83.3^{(l)} |
| PIQA | Accuracy | Test | Lourie et al. | 90.1 | 90.7^{(l)} |
| CSQA | Accuracy | Dev | Lourie et al. | 79.1 | 84.9 |
| CSQA2 | Accuracy | Test | Lourie et al. | 69.6^{(#)} | 70.1^{(l)} |
| QASC (w/o IR) | Accuracy | Dev | Khashabi et al. | 81.8 | 83.8 |
| QASC (w lR) | Accuracy | Tost | Khashabi et al. | 89.6 | 90.7^{(l)} |
| TweetQA | BLEU-1 | Dev | Khashabi et al. | 77.5 | 78.4 |
| QuAIL | Accuracy | Test | Khashabi et al. | 74.2 | 87.2 |
| AdversarialQA | F1 | Dev | Khashabi et al. | 53.6 | 70.1 |
| (Bert) | | | | | |
| AdversarialQA | F1 | Dev | Khashabi et al. | 45.5 | 57.5 |
| (Roberta) | | | | | |
| AdversarialQA | F1 | Dev | Khashabi et al. | 71.5 | 77.5 |
| (Bidaf) | | | | | |
| MCScript | Accuracy | Test | Khashabi et al | 95.1 | 97.3 |
| MCScript 2.0 | Accuracy | Test | Khashabi et al. | 94.6 | 97.9 |
| RACE | Accuracy | Test | Shoeybi et al. | 90.9^{(e)} | 90.9 |
| DREAM | Accuracy | Test | Wan | 91.8 | 91.8 |
| OBQA | Accuracy | Test | Khashabi et al. | 87.2 | 87.2^{(l)} |
| CosmosQA | Accuracy | Test | Lourie et al. | 91.8 | 91.6^{(l)} |
| Winogrande XL | Accuracy | Test | Lourie et al. | 91.3 | 90.1^{(l)} |
| DocNLI | Accuracy | Test | Qin et al. | 76.9 | 88.2 |
| AdversarialNLI (r3) | Accuracy | Test | Wang et al | 47.7 | 53.5 |
| VitaminC | Accuracy | Test | Schuster et al. | 90.8 | 91.1 |
| Hellaswag | Accuracy | Test | Lourie et al. | 93.9 | 94.1^{(l)} |
| QQP | F1 | Dev | Raffel et al. | 90.1 | 90.6 |
| QNLI | Accuracy | Dev | Raffel et al. | 96.1 | 96.5 |
| CoLA | Matthews | Dev | Raffel et al. | 68.6 | 71.5 |
| STSB | Spearman | Dev | Raffel et al. | 92.1 | 92.3 |
| AbductiveNLI | Accuracy | Test | He et al. | 89.8^{(#)} | 87.5^{(l)} |
| MultiNLI | Accuracy | Dev | Raffel et al. | 92.1 | 91.9 |
| IMDB | Accuracy | Test | Yang et al. | 96.2 | 97.3 |
| AgNews | Error | Test | Yang et al. | 4.45 | 4.42 |
| Civil Comments | F1 | Dev | Tay et al. | 87.8 | 87.9 |
| Wikipedia Toxicity | F1 | Dev | Tay et al. | 96.5 | 97.0 |
| SST-2 | Ace | Dev | Raffel et al. | 97.3 | 97.0 |
| Scrolls Challenge | Aggregate | Test | Shaham et al. | 29.2 | 37.9^{(l)} |
| SumScr | Rouge(Avg) | Test | Shaham et al. | 16.3 | 20.0^{(l)} |
| QMSum | Rouge(Avg) | Test | Shaham et al. | 19.9 | 20.0^{(l)} |
| QASPER | F1 | Test | Shaham et al. | 26.6 | 37.6^{(l)} |
| NarrativeQA | F1 | Test | Shaham et al. | 18.5 | 24.2^{(l)} |
| QUALITY | EM | Test | Shaham et al. | 26.0 | 45.8^{(l)} |
| ContractNLI | EM | Test | Shaham et al. | 77.4 | 88.7^{(l)} |
| GovRep | Rouge(Avg) | Test | Shaham et al. | 37.2 | 36.2^{(l)} |
| WikiTQ | Accuracy | Test | Xie et al. | 49.3 | 54.6 |
| CompWebQ | Accuracy | Test | Xie et al. | 73.3 | 75.9 |
| FetaQA | BLEU-4 | Test | Xie et al. | 33.4 | 35.8 |
| HybridQA | Accuracy | Dev | Eisenschlos et al. | 60.8 | 61.0 |
| WikiSQL | Accuracy | Test | Xie et al. | 86.0 | 87.3 |
| TabFat | Accuracy | Test | Xie et al. | 83.4 | 87.1 |
| Feverous | Accuracy | Dev | Xie et al. | 82.4 | 85.6 |
| SQA | Sent.Acc | Test | Xie et al. | 62.4 | 70.5 |
| MTOP | Match | Test | Xie et al. | 86.8 | 87.5 |
| DART | BLEU-4 | Test | Aghajanyan et al. | 47.2 | 50.4 |
| DSI-NQ | HITS@10 | Dev | Tay et al. | 70.3 | 73.8 |

^{(l)}denotes leaderboard submission.
^{(#)}denotes the best published found on the respective leaderboard.
^{(e)}denotes SOTA used an ensembled approach.

UL2 achieves at least SOTA performance on around 50+ NLP tasks and setups. For many, the margins are quite wide and for those that UL2 doesn't achieve SOTA, the performance of UL2 is generally quite competitive. The extent of difficulty of obtaining SOTA on each benchmark has vastly different difficulties. For some, the SOTA model is a 32B dense equivalent (Zoph et al., 2022). For some others, it's a base model.

### Example Methods

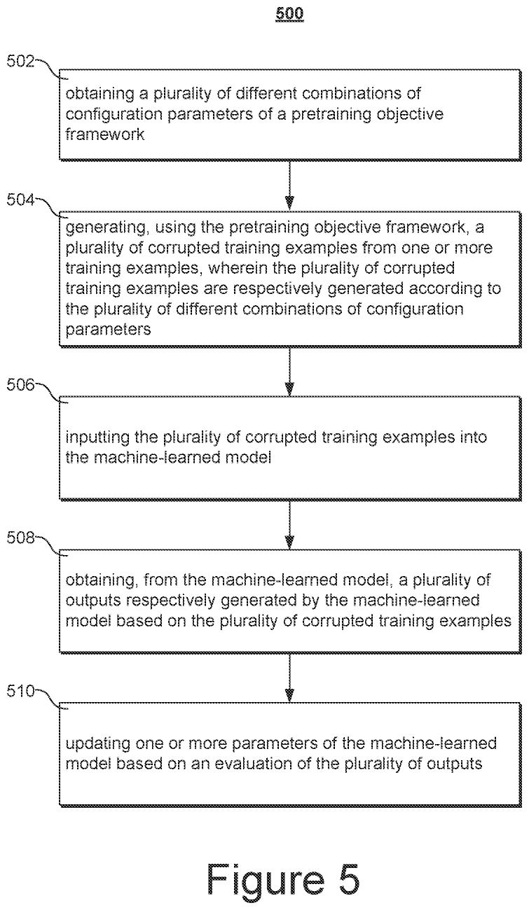

FIG. 5 depicts a flow chart diagram of an example method to perform according to example embodiments of the present disclosure. Although FIG. 5 depicts steps performed in a particular order for purposes of illustration and discussion, the methods of the present disclosure are not limited to the particularly illustrated order or arrangement. The various steps of the method 500 can be omitted, rearranged, combined, and/or adapted in various ways without deviating from the scope of the present disclosure.

At 502, example method 500 can include obtaining a plurality of different combinations of configuration parameters of a pretraining objective framework. The pretraining objective framework (e.g., including pretraining pipeline 200) can include a parameterized corruption function that is configured to generate training examples according to one or more configuration parameters. For instance, the parameterized corruption function can be configured to receive original training examples (e.g., sequences of text, etc.) and output corrupted training examples. A plurality of different combinations of configuration parameters can respectively correspond to a plurality of objective configurations, such as objective configurations 206-212. A plurality of different combinations of configuration parameters can be obtained from a configuration file or other parameter storage.

At 504, example method 500 can include generating, using the pretraining objective framework, a plurality of corrupted training examples from one or more training examples. The plurality of corrupted training examples can be respectively generated according to the plurality of different combinations of configuration parameters. For instance, a different corrupted training example can be generated according to each of the plurality of different combinations of configuration parameters (e.g., according to each of a plurality of objective configurations).

At 506, example method 500 can include inputting the plurality of corrupted training examples into the machine-learned model. The machine-learned model can be configured to generate uncorrupted subportions corresponding to corrupted subportions of the corrupted training examples. For example, the machine-learned model can be configured to perform next-word generation based on surrounding context. The machine-learned model can be configured to leverage uncorrupted tokens bidirectionally as inputs for predicting the corrupted subportion.

At 508, example method 500 can include obtaining, from the machine-learned model, a plurality of outputs respectively generated by the machine-learned model based on the plurality of corrupted training examples.

At 510, example method 500 can include updating one or more parameters of the machine-learned model based on an evaluation of the plurality of outputs.

In some implementations of example method 500, the configuration parameters can include two or more different parameters of: a subportion length parameter, a subportion quantity parameter, or a corruption rate parameter.

In some implementations of example method 500, the plurality of different combinations of configuration parameters can include a distributed configuration configured for generating a plurality of corrupted subportions distributed over a training example and a sequential configuration configured for generating a corrupted subportion corresponding to a terminus of the training example.

In some implementations of example method 500, the plurality of different combinations of configuration parameters can include a first distributed configuration configured for generating a first plurality of corrupted subportions distributed over a training example; a second distributed configuration configured for generating a second plurality of corrupted subportions distributed over the training example; and a sequential configuration configured for generating a corrupted subportion corresponding to a terminus of the training example. In some implementations of example method 500, the second distributed configuration can be configured to cause greater corruption of the training example than the first distributed configuration

In some implementations of example method 500, as compared to the first distributed configuration, the second distributed configuration can include at least one of: a subportion length parameter corresponding to a longer subportion length; or a corruption rate parameter corresponding to a greater rate of corruption.

In some implementations of example method 500, the sequential configuration can correspond to a prefix-based language modeling objective.

In some implementations of example method 500, the plurality of different combinations of configuration parameters can include: a first plurality of distributed configurations that can be respectively associated with subportion length parameters indicating subportion lengths of less than about 12 tokens; and a second plurality of distributed configurations that can be respectively associated with at least one of: subportion length parameters indicating subportion lengths of greater than about 12 tokens; or corruption rate parameters indicating a corruption rate of greater than about 30%. In some implementations of example method 500, the plurality of different combinations of configuration parameters can include a sequential configuration. In some implementations of example method 500, the plurality of different combinations of configuration parameters can include a quantity of one or more sequential configurations such that the quantity is less than about 50% of the total quantity of the plurality of configurations. In some implementations of example method 500, the plurality of different combinations of configuration parameters can include a quantity of one or more sequential configurations such that the quantity is about 20% of the total quantity of the plurality of configurations.

In some implementations of example method 500, the first plurality of distributed configurations can be respectively associated with subportion length parameters indicating subportion lengths of less than about 10 tokens.

In some implementations of example method 500, the second plurality of distributed configurations can be respectively associated with subportion length parameters indicating subportion lengths of greater than about 12 tokens. In some implementations of example method 500, the second plurality of distributed configurations can be respectively associated with subportion length parameters indicating subportion lengths of greater than about 30 tokens.

In some implementations of example method 500, the second plurality of distributed configurations can be respectively associated with corruption rate parameters indicating a corruption rate of greater than about 30%. In some implementations of example method 500, the second plurality of distributed configurations can be respectively associated with corruption rate parameters indicating a corruption rate of at least about 50%.

In some implementations of example method 500, generating a plurality of corrupted training examples from the one or more training examples can include, for a respective training example of the one or more training examples (the respective training example including a respective sequence of data tokens), determining one or more selected subportions of the respective sequence of data tokens; and replacing the one or more selected subportions with a replacement token.

In some implementations of example method 500, the example method 500 can include inputting, with a respective corrupted training example of the plurality of corrupted training examples, a mode-switching token (e.g., modal token, such as “[R],” “[X],” “[S],” etc.) corresponding to at least one configuration of the plurality of different combinations of configuration parameters, the at least one configuration used to corrupt the respective corrupted training example.

In some implementations of example method 500, the mode-switching token can trigger downstream behavior of the machine-learned model corresponding to tasks prioritized by the at least one configuration. For instance, the mode-switching token can be prepended to runtime inputs (e.g., at inference time) based on the type of task associated with the runtime input. For instance, short form generative tasks can use a mode-switching token associated with short form corrupted spans (e.g., “[R]”). Long form generative tasks can use a mode-switching token associated with long form corrupted spans (e.g., “[X]” or “[S]”).

In some implementations of example method 500, at least one of the corruption parameters can be a probabilistic parameter. In some implementations of example method 500, the probabilistic parameter can be the corrupted subportion length parameter characterizing a distribution from which a selected subportion length is sampled. In some implementations of example method 500, the probabilistic parameter can be the corruption rate parameter characterizing a rate at which one or more selected subportions of a training example are corrupted.

In some implementations of example method 500, the sequence of data tokens can correspond to natural language.

In some implementations of example method 500, the sequence of data tokens can correspond to genetic data.

In some implementations of example method 500, the sequence of data tokens can correspond to textual data.

In some implementations of example method 500, the machine-learned model can include a transformer encoder. In some implementations of example method 500, the machine-learned model can include a transformer decoder.

In some implementations of example method 500, the example method 500 can include generating a first fine-tuned version of the machine-learned model for a first task; and generating a second fine-tuned version of the machine-learned model for a second, different task.

In some implementations of example method 500, the first task can be at least one of a classification task or a sequence-to-sequence task. In some implementations of example method 500, the second, different task can be at least one of an open-text generation or prompt-based inference task.

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Also, terms such as “based on” should be understood as “based at least in part on.”

1. A computer-implemented method for pretraining a machine-learned model with diversified objectives, comprising:
obtaining, by a computing system comprising one or more processors, a plurality of different combinations of configuration parameters of a pretraining objective framework;
generating, by the computing system and using the pretraining objective framework, a plurality of corrupted training examples from one or more training examples, wherein the plurality of corrupted training examples are respectively generated according to the plurality of different combinations of configuration parameters;
inputting, by the computing system, the plurality of corrupted training examples into the machine-learned model, wherein the machine-learned model is configured to generate uncorrupted subportions corresponding to corrupted subportions of the corrupted training examples;
obtaining, by the computing system and from the machine-learned model, a plurality of outputs respectively generated by the machine-learned model based on the plurality of corrupted training examples; and
updating, by the computing system, one or more parameters of the machine-learned model based on an evaluation of the plurality of outputs.

2. The method of claim 1, wherein the configuration parameters comprise two or more different parameters of: a subportion length parameter, a subportion quantity parameter, or a corruption rate parameter.

3. The method of claim 1, wherein the plurality of different combinations of configuration parameters comprise:
a distributed configuration configured for generating a plurality of corrupted subportions distributed over a training example; and
a sequential configuration configured for generating a corrupted subportion corresponding to a terminus of the training example.

4. The method of claim 1, wherein the plurality of different combinations of configuration parameters comprise:
a first distributed configuration configured for generating a first plurality of corrupted subportions distributed over a training example;
a second distributed configuration configured for generating a second plurality of corrupted subportions distributed over the training example, wherein the second distributed configuration is configured to cause greater corruption of the training example than the first distributed configuration; and
a sequential configuration configured for generating a corrupted subportion corresponding to a terminus of the training example.

5. The method of claim 4, wherein, as compared to the first distributed configuration, the second distributed configuration comprises at least one of:
a subportion length parameter corresponding to a longer subportion length; or
a corruption rate parameter corresponding to a greater rate of corruption.

6. The method of claim 4, wherein the sequential configuration corresponds to a prefix-based language modeling objective.

7. The method of claim 1, wherein the plurality of different combinations of configuration parameters comprises:
a first plurality of distributed configurations that are respectively associated with subportion length parameters indicating subportion lengths of less than about 12 tokens;
a second plurality of distributed configurations that are respectively associated with at least one of:
subportion length parameters indicating subportion lengths of greater than about 12 tokens; or
corruption rate parameters indicating a corruption rate of greater than about 30%.

8. The method of claim 7, wherein the first plurality of distributed configurations are respectively associated with subportion length parameters indicating subportion lengths of less than about 10 tokens.

9. The method of claim 8, wherein the second plurality of distributed configurations are respectively associated with subportion length parameters indicating subportion lengths of greater than about 12 tokens.

10. The method of claim 9, wherein the second plurality of distributed configurations are respectively associated with subportion length parameters indicating subportion lengths of greater than about 30 tokens.

11. The method of claim 9, wherein the second plurality of distributed configurations are respectively associated with corruption rate parameters indicating a corruption rate of greater than about 30%.

12. The method of claim 11, wherein the second plurality of distributed configurations are respectively associated with corruption rate parameters indicating a corruption rate of at least about 50%.

13. The method of claim 1, wherein generating a plurality of corrupted training examples from the one or more training examples comprises:
for a respective training example of the one or more training examples, the respective training example comprising a respective sequence of data tokens:
determining, by the computing system, one or more selected subportions of the respective sequence of data tokens; and
replacing, by the computing system, the one or more selected subportions with a replacement token.

14. The method of claim 1, comprising:
inputting, by the computing system and with a respective corrupted training example of the plurality of corrupted training examples, a mode-switching token corresponding to at least one configuration of the plurality of different combinations of configuration parameters, the at least one configuration used to corrupt the respective corrupted training example.

15. The method of claim 14, wherein the mode-switching token triggers downstream behavior of the machine-learned model corresponding to tasks prioritized by the at least one configuration.

16. The method of claim 1, wherein at least one of the corruption parameters is a probabilistic parameter.

17. The method of claim 16, wherein the probabilistic parameter is the subportion length parameter characterizing a distribution from which a selected subportion length is sampled.

18. The method of claim 16, wherein the probabilistic parameter is the corruption rate parameter characterizing a rate at which one or more selected subportions of a training example are corrupted.

19. A non-transitory, computer-readable medium storing instructions that are executable by one or more processors to cause a computing system to perform operations, the operations comprising:
obtaining a plurality of different combinations of configuration parameters of a pretraining objective framework;
generating, using the pretraining objective framework, a plurality of corrupted training examples from one or more training examples, wherein the plurality of corrupted training examples are respectively generated according to the plurality of different combinations of configuration parameters;
inputting the plurality of corrupted training examples into the machine-learned model, wherein the machine-learned model is configured to generate uncorrupted subportions corresponding to corrupted subportions of the corrupted training examples;
obtaining, from the machine-learned model, a plurality of outputs respectively generated by the machine-learned model based on the plurality of corrupted training examples; and
updating one or more parameters of the machine-learned model based on an evaluation of the plurality of outputs.

20. A computing system, comprising:
one or more processors; and
a non-transitory, computer-readable medium storing instructions that are executable by the one or more processors to cause the computing system to perform operations, the operations comprising:
obtaining a plurality of different combinations of configuration parameters of a pretraining objective framework;
generating, using the pretraining objective framework, a plurality of corrupted training examples from one or more training examples, wherein the plurality of corrupted training examples are respectively generated according to the plurality of different combinations of configuration parameters;
inputting the plurality of corrupted training examples into the machine-learned model, wherein the machine-learned model is configured to generate uncorrupted subportions corresponding to corrupted subportions of the corrupted training examples;
obtaining, from the machine-learned model, a plurality of outputs respectively generated by the machine-learned model based on the plurality of corrupted training examples; and
updating one or more parameters of the machine-learned model based on an evaluation of the plurality of outputs.

21-27. (canceled)
